(19) United States
(12) Patent Application Publication
(10) Pub. No.: US 2026/0161140 A1
(43) Pub. Date: Jun. 11, 2026

(54) ELECTRONIC DEVICE AND CONTROLLING METHOD THEREOF

(71) Applicant: SAMSUNG ELECTRONICS CO., LTD., Suwon-si (KR)

(72) Inventors: Sukun YOON, Suwon-si (KR); Seungwon CHA, Suwon-si (KR); Junghee KIM, Suwon-si (KR)

(73) Assignee: SAMSUNG ELECTRONICS CO., LTD., Suwon-si (KR)

(21) Appl. No.: 19/461,027

(22) Filed: Jan. 27, 2026

Related U.S. Application Data
(63) Continuation of application No. PCT/KR2025/021073, filed on Dec. 9, 2025.

(30) Foreign Application Priority Data
Dec. 10, 2024 (KR) 10-2024-0183135

(51) Int. Cl. G05B 13/02; G05D 1/689

(52) U.S. Cl. CPC G05B 13/0265; G05D 1/689

(57) ABSTRACT

An electronic device may include: a communication circuit, a memory configured to store instructions, and one or more processors including processing circuitry configured to, individually or collectively, execute the stored instructions to: obtain integrated data including operation information of a plurality of devices, location information of the plurality of devices, and location information of a user, obtain group information including at least one device among the plurality of devices through an artificial intelligence model based on the integrated data; and transmit a control signal identified based on the integrated data and the group information to at least one device included in the same group through a communication circuit.

### CROSS-REFERENCE TO RELATED APPLICATIONS

This is a continuation application, under 35 U.S.C. § 111(a), of International Application No. PCT/KR2025/021073, filed Dec. 9, 2025, which claims priority under 35 U.S.C. § 119 to Korean Patent Application No. 10-2024-0183135, filed Dec. 10, 2024, in the Korean Intellectual Property Office, the disclosures of which are incorporated herein in their entireties by reference.

### TECHNICAL FIELD

The present disclosure relates to an electronic device and a controlling method thereof.

### BACKGROUND ART

Recently, with the development of AI home robot technology, technology to integrate and control a plurality of home appliances using AI home robots is being developed.

An AI home robot can move throughout an indoor space to assist users in their daily lives and perform appropriate operations to support users in living a convenient and efficient life. AI home robots can integrate and control multiple home appliances disposed in the home so that users can use them more efficiently and conveniently.

### DISCLOSURE OF INVENTION

### Solution to Problem

In accordance with the present disclosure, an electronic device may include: a communication circuit; a memory configured to store instructions; and one or more processors including processing circuitry configured to, individually or collectively, execute the stored instructions to: obtain integrated data including operation information of a plurality of devices, location information of the plurality of devices, and location information of a user, obtain group information including at least one device among the plurality of devices by inputting the integrated data into an artificial intelligence model, and transmit a control signal identified based on the integrated data and the group information to at least one device included in the same group through the communication circuit.

According to one or more embodiments, the electronic device may further include a sensor, and the instructions, when executed by the one or more processors individually or collectively, may cause the electronic device to, based on a user being identified based on data obtained by the sensor, obtain group information corresponding to the identified user by inputting information corresponding to the identified user and the integrated data into the artificial intelligence model, and transmit a control signal identified based on the group information corresponding to the identified user and the integrated data to at least one device included in the same group through the communication circuit.

According to one or more embodiments, the instructions, when executed by the one or more processors individually or collectively, may cause the electronic device to receive operation data for each of the plurality of devices, which is a basis of the integrated data, from each of the plurality of devices through the communication circuit.

According to one or more embodiments, the electronic device may further include a sensor, and the instructions, when executed by the one or more processors individually or collectively, may cause the electronic device to move to a location of each of the plurality of devices and obtain operation data for each of the plurality of devices based on data obtained through the sensor.

According to one or more embodiments, the instructions, when executed by the one or more processors individually or collectively, may cause the electronic device to, based on a signal corresponding to a communication connection being received from a device through the communication circuit, transmit the integrated data to the device through the communication circuit, and operate in conjunction with the device that received the integrated data.

According to one or more embodiments, the electronic device may further include a sensor, and the instructions, when executed by the one or more processors individually or collectively, may cause the electronic device to obtain information corresponding to a space where the electronic device is located based on data obtained by the sensor, and obtain the control signal based on information corresponding to the space, the group information and the integrated data.

According to one or more embodiments, the electronic device may further include a speaker, and the instructions, when executed by the one or more processors individually or collectively, may cause the electronic device to output information corresponding to a control signal identified based on the group information and the integrated data through the speaker, and based on a user input for information corresponding to the control signal being received, transmit the control signal to at least one home appliance through the communication circuit.

According to one or more embodiments, the electronic device may further include a projector, and the instructions, when executed by the one or more processors individually or collectively, may cause the electronic device to project information corresponding to a control signal identified based on the group information and the integrated data through the projector, and based on a user input for information corresponding to the control signal being received, transmit the control signal to the at least one home appliance through the communication circuit.

According to one or more embodiments, the electronic device may further include an IR sensor, and the instructions, when executed by the one or more processors individually or collectively, may cause the electronic device to, based on a communication connection with a first device included in the same group being not possible, move to a location of the first device and output an IR signal corresponding to the control signal through the IR sensor.

According to one or more embodiments, the instructions, when executed by the one or more processors individually or collectively, may cause the electronic device to obtain the integrated data corresponding to the operation information of the plurality of devices for each user location based on a plurality of operation data and user location data for each space received from the plurality of devices.

A controlling method of an electronic device according to one or more embodiments includes obtaining integrated data including operation information of a plurality of devices, location information of the plurality of devices, and location information of a user, obtaining group information including at least one device among the plurality of devices by inputting the integrated data into an artificial intelligence model, and transmitting a control signal identified based on the integrated data and the group information to at least one device included in the same group.

In a non-transitory computer-readable recording medium storing computer instructions that, when executed by a processor of an electronic device, cause the electronic device to perform operations, the operations include obtaining integrated data including operation information of a plurality of devices, location information of the plurality of devices, and location information of a user, obtaining group information including at least one device among the plurality of devices by inputting the integrated data into an artificial intelligence model, and transmitting a control signal identified based on the integrated data and the group information to at least one device included in the same group.

### BRIEF DESCRIPTION OF DRAWINGS

FIG. 1 is a view provided to explain an operation of an electronic device according to one or more embodiments;

FIG. 2 is a block diagram provided to explain configuration of an electronic device according to one or more embodiments;

FIG. 3 is a block diagram provided to explain detailed configuration of an electronic device according to one or more embodiments;

FIG. 4 is a view provided to explain a process of obtaining integrated data of an electronic device according to one or more embodiments;

FIG. 5 is a view provided to explain integrated data according to one or more embodiments;

FIG. 6 is a view provided to explain a process of transmitting integrated data of an electronic device according to one or more embodiments;

FIG. 7 is a view provided to explain a process of obtaining group information of an electronic device according to one or more embodiments;

FIG. 8 is a view provided to explain a process of obtaining group information for each user of an electronic device according to one or more embodiments;

FIG. 9 is a view provided to explain a process of transmitting a control signal of an electronic device according to one or more embodiments;

FIG. 10 is a view provided to explain a process of providing guide information of an electronic device according to one or more embodiments;

FIGS. 11 and 12 are views provided to explain a process of providing information through a projector of an electronic device according to one or more embodiments;

FIG. 13 is a view provided to explain a process of controlling a home appliance using an IR signal according to one or more embodiments; and

FIG. 14 is a view provided to explain an operation process of an electronic device according to one or more embodiments;

### MODE FOR INVENTION

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, an expression “have”, “may have”, “include”, “may include” or the like, indicates the existence of a corresponding feature (e.g., a numerical value, a function, an operation or a component such as a part), and does not exclude the existence of an additional feature.

An expression, “at least one of A or/and B” should be understood as indicating any one of “A”, “B” and “both of A and B.”

Expressions “1st”, “2nd”, “first”, “second”, and the like, used in the disclosure may indicate various components regardless of the sequence and/or importance of the components. These expressions are used only to distinguish one component from another component, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

A term of a singular number may include its plural number unless explicitly indicated otherwise in the context. It is to be understood that a term “include”, “formed of”, or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

In the disclosure, a “module” or a “unit” may perform at least one function or operation, and be implemented by hardware or software or be implemented by a combination of hardware and software. In addition, a plurality of “modules” or a plurality of “units” may be integrated into at least one module and be implemented by at least one processor (not shown) except for a ‘module’ or a ‘unit’ that needs to be implemented by specific hardware.

In this specification, a term ‘user’ may refer to a person using an electronic device or a device used by the person.

Hereinafter, an embodiment of the present disclosure will be described in greater detail with reference to the accompanying drawings.

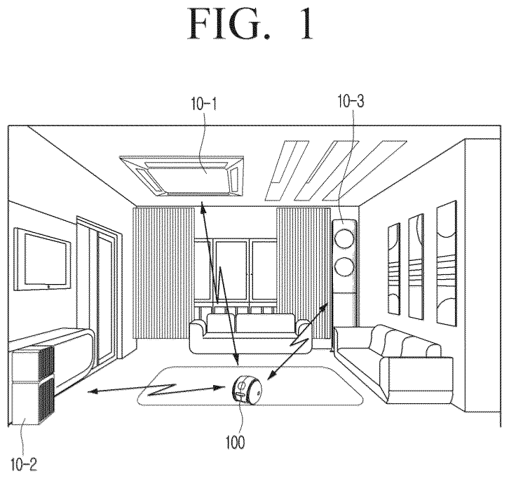

FIG. 1 is a view provided to explain an operation of an electronic device according to one or more embodiments.

According to an embodiment, an electronic device 100 may perform communication with a plurality of home appliances and transmit a control signal. Here, the electronic device 100 may be a mobile electronic device including a projector. The electronic device 100 may be implemented as various electronic devices such as a mobile robot, a robot cleaner, an Automated Guided Vehicle (AGV), an Autonomous Mobile Robot (AMR), a social robot, a projector, a portable projector, a tablet, a mobile device, a laptop, etc.

According to an embodiment, the electronic device 100 may include a display. Specifically, the electronic device 100 may directly display an obtained image or content on the display.

According to an embodiment, the electronic device 100 may not include a display. The electronic device 100 may be connected to an external display device, and may transmit an image or content stored in the electronic device 100 to the external display device.

The electronic device 100 may transmit an image or content to an external display device together with a control signal for controlling the image or content to be displayed on the external display device. Here, the external display device may be connected to the electronic device 100 through a communication circuit 110 or an input/output interface 190. For example, the electronic device 100 may not include a display, such as a set top box (STB).

For example, the electronic device 100 may include only a small display capable of displaying only simple information such as text information. The electronic device 100 may transmit an image or content to an external display device through the communication circuit 110 via wire or wirelessly or may transmit an image or content to the external display device through the input/output interface 190.

According to an embodiment, the electronic device 100 may receive operation log data for each of a plurality of devices from a plurality of home appliances. The operation log data may include data related to the operating status and performance generated while the device is in operation. For example, the operation log data may include data corresponding to the operation start time, operation duration, energy consumption, operation mode, and operation setting values of the device. The electronic device 100 may receive operation log data from each of a plurality of devices and identify the operation patterns of the respective devices based on the operation log data.

According to an embodiment, the electronic device 100 may move through a space and identify location log data of a user for each space. The location log data of a user for each space may include data on the user's movement path, movement time, movement pattern, and duration of stay for each space. For example, the electronic device 100 may classify an indoor space into a living room, a room, and a bathroom, and may identify log data on the user's duration of stay and movement time for each space.

According to an embodiment, the electronic device 100 may identify integrated data based on operation log data for each of a plurality of devices and location log data of the user for each space.

The integrated data may be data that includes operation information of each of the plurality of devices based on the user's location. For example, the integrated data may be data that integrates the user's location log data for the living room space among the spaces inside the house and the operation log data of each of the plurality of devices located in the living room space.

Referring to FIG. 1, the electronic device 100 may move through a space and receive, from a plurality of devices 10-1 to 10-3, operation log data for each of the devices 10-1 to 10-3. The electronic device 100 may identify the user's location through a sensor 140, and may obtain the user's location log data based on the identified user's location. The electronic device 100 may identify integrated data based on the operation log data of the devices and the user's location log data.

According to an embodiment, the electronic device 100 may group devices to include at least one device among a plurality of devices and control the devices by group. The electronic device 100 may control the devices by group based on the identified integrated data.

Hereinafter, with reference to the drawing, various embodiments in which the electronic device 100 obtains group information including at least one device among a plurality of devices, and transmits a control signal to the devices based on the integrated data will be described.

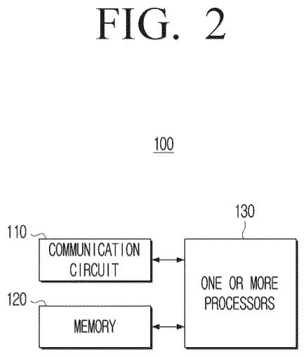

FIG. 2 is a block diagram provided to explain configuration of an electronic device according to one or more embodiments.

According to FIG. 2, the electronic device 100 includes the communication circuit 110, memory 120 and one or more processors 130. However, the electronic device 100 is not limited thereto, and the electronic device 100 may be implemented in a form in which some components are excluded or may be implemented in a form in which other components are further included.

The communication circuit 110 may include a wired or wireless input/output interfaces (or input/output terminal) according to various standards. The communication circuit 110 may be configured to perform communication with various types of external devices according to various types of communication methods. The communication circuit 110 may include a wireless communication module or a wired communication module. Here, each communication module may be implemented in the form of at least one hardware chip.

The communication circuit 110 may include various interfaces such as High Definition Multimedia Interface (HDMI), Mobile High-Definition Link (MHL), Universal Serial Bus (USB), Display Port (DP), Thunderbolt, Video Graphics Array (VGA) port, RGB port, D-subminiature (D-SUB), Digital Visual Interface (DVI), Bluetooth, Zigbee, Local Area Network (LAN) via wired/wireless connection, Wide Area Network (WAN), Ethernet, IEEE 1394, Audio Engineering Society/European Broadcasting Union (AES/EBU), optical, and coaxial.

The memory 120 may store at least one instruction, data, program, etc. required for the operation of the electronic device 100. For example, the memory 120 may store outline emphasis processing information and location information corresponding to a selected image.

The memory 120 may be implemented as memory embedded in the electronic device 100 or as memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100.

The memory embedded in the electronic device 100 may be implemented as at least one of volatile memory (e.g. a dynamic RAM (DRAM), a static RAM (SRAM), or a synchronous dynamic RAM (SDRAM)) or non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, flash memory (e.g. a NAND flash or a NOR flash), a hard drive, or a solid state drive (SSD)).

The memory 120 may be implemented as single memory that stores data generated from various operations according to the present disclosure, but is not limited thereto, and the memory 120 may be implemented to include a plurality of memories that each store different types of data or each store data generated at different stages.

The one or more processors 130 may control the overall operations of the electronic device 100. Specifically, the one or more processors 130 may be connected to each component of the electronic device 100 and control the overall operations of the electronic device 100. For example, the one or more processors 130 may be electrically connected to the communication circuit 110 and the memory 120 to control the overall operations of the electronic device 100. The one or more processors 130 may consist of one or multiple processors.

The one or more processors 130, by executing one or more instructions stored in the memory 120, may perform the operations of the electronic device 100 according to various embodiments.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or any combination of the other components of the electronic device, and may perform communication-related operations or data processing. The one or more processors 130 may execute at least one program or instruction stored in the memory. For example, one or more processors may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 130 may be implemented as a single core processor including a single core, or as one or more multicore processors including a plurality of cores (e.g., homogeneous multicore or heterogeneous multicore). When the one or more processors 130 are implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the core is not limited to the embodiments of the present disclosure. Hereinafter, the one or more processors 130 will be referred to as the processor 130 for convenience of explanation.

According to an embodiment, the processor 130 may obtain integrated data corresponding to operation information of a plurality of devices for each user location.

According to an embodiment, the processor 130 may identify integrated data including operation information of a plurality of devices for each location of the user based on a plurality of operation log data received from the plurality of devices and location log data of the user for each space.

The integrated data may be data that integrates log data of devices operated at a specific point in time and location log data of the user. For example, if the user is located in the living room at 12 PM and an air conditioner and an air purifier disposed in the living room are operating, the integrated data may include operation information of the plurality of devices in the living room at 12 PM.

According to an embodiment, the processor 130 may obtain group information including at least one device among a plurality of devices by inputting integrated data into an artificial intelligence model.

The group information may include information about a group including at least one device among a plurality of devices, based on the functions of the devices, the user's lifestyle patterns, and device usage information for each user. For example, the group information may include information in which an air conditioner, a fan, and an air purifier are grouped into one group according to an air blowing function.

According to an embodiment, the processor 130 may transmit a control signal identified based on group information and integrated data to at least one device included in the same group through the communication circuit 110.

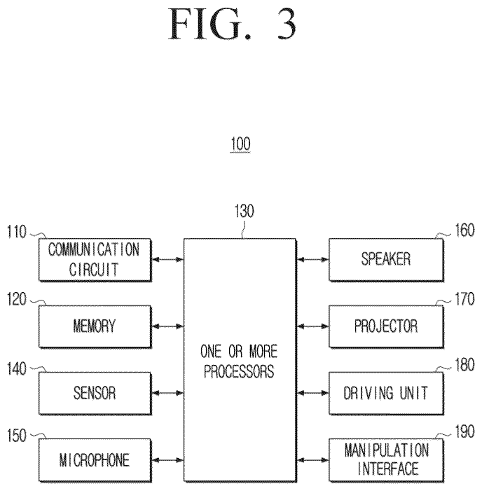

FIG. 3 is a block diagram provided to explain detailed configuration of an electronic device according to one or more embodiments.

According to FIG. 3, the electronic device 100 includes the communication circuit 110, the memory 120, the one or more processors 130, a sensor 140, a microphone 150, a speaker 160, a projector 170, a driving unit 180, and the input/output interface 190. A detailed description of any configurations illustrated in FIG. 3 that overlap with those illustrated in FIG. 2 will be omitted.

The sensor 140 is configured to move through a space and identify a receiver. The sensor 140 may include at least one of IR sensor, Lidar sensor, depth camera, Inertial Measurement Unit (IMU) sensor, Time of Flight (ToF) sensor, vision sensor, light sensor, RGB sensor, image sensor, infrared sensor, ultrasonic sensor, gyroscope sensor, acceleration sensor, or proximity sensor.

A Lidar sensor may emit light (e.g., laser, near-infrared light, visible light, ultraviolet light, etc.) in 360 degrees around the surroundings, and may output sensing information for obtaining information about distances to surrounding objects by detecting light reflected by various surrounding objects (e.g., walls, furniture, home appliances, etc.). A depth camera is a sensor that projects laser or infrared light onto external objects and receives the reflected light through a stereo camera, thereby measuring the distance to the external objects in a three-dimensional manner to sense depth data. An Inertial Measurement Unit (IMU) sensor is a sensor for detecting a movement of the electronic device, and may include at least one of a geomagnetic sensor, an acceleration sensor, or a gyroscope sensor. A Time of Flight (ToF) sensor may output a signal such as a laser, and measure a distance to an external object using the time it takes for the reflected signal to be received.

The microphone 150 is configured to receive a user voice or other sounds and convert it into audio data. The processor 130 may control the projector 170 based on a user voice signal received through the microphone 150.

The speaker 160 may convert a digital acoustic signal processed by the processor 130 to an analog acoustic signal, and amplify and output the same. For example, the speaker 160 may include at least one speaker unit, a D/A converter, an audio amplifier, or the like, capable of outputting at least one channel. For example, the speaker 160 may output information corresponding to a caller and calling intention for a received call.

The projector 170 is configured to project (or cast) an image. The projector 170 may include a light source, at least one lens (not shown), a reflector, etc. The projector 170 may project an image using one projection method among a cathode-ray tube (CRT) method, a Liquid Crystal Display (LCD) method, a Digital Light Processing (DLP) method, and a laser method.

The projector 170 may perform various functions under the control of the processor 130. For example, the projector 170 may adjust a focus of an image according to a distance to a floor surface (e.g., a projection distance), or may perform a keystone correction function. The keystone correction function refers to a function of correcting a distorted image. For example, when distortion of the image occurs in the left-right direction, the projector 170 may perform horizontal keystone correction, and when distortion of the image occurs in the up-down direction, the projector 170 may perform vertical keystone correction. In addition, when corners of an area are out of alignment, the projector 170 may perform quick corner keystone correction for correcting the same.

The driving unit 180 is configured to move the main body of the electronic device 100. The driving unit 180 includes a plurality of wheels, a drive motor for rotating each of the plurality of wheels, a gear, a shaft, etc. The plurality of wheels are provided on the lower or side surface of the main body of the electronic device 100, and support the main body of the electronic device 100 from the floor surface. When the drive motor operates and its driving force is transmitted to the plurality of wheels to rotate each wheel, the electronic device 100 can be moved by the frictional force between the floor surface and the wheels. In addition, the driving unit 180 may adjust the rotation speed of at least one of the plurality of wheels or change the alignment direction of the wheels when changing direction. Depending on the type of the electronic device 100 and the characteristics of the space in which the electronic device 100 is located (e.g., floor roughness, frictional force, etc.), a continuous track or the like may be used instead of a wheel.

The input/output interface 190 may be any one of the following interfaces: High Definition Multimedia Interface (HDMI), Mobile High-Definition Link (MHL), Universal Serial Bus (USB), Display Port (DP), Thunderbolt, Video Graphics Array(VGA) port, RGB port, D-subminiature (D-SUB), and Digital Visual Interface (DVI).

The input/output interface 190 may input/output at least one of audio and video signals. Depending on the implementation example, the input/output interface 190 may include a port that inputs/outputs only audio signals and a port that inputs/outputs only video signals as separate ports, or may be implemented as a single port that inputs/outputs both audio signals and video signals.

The electronic device 100 may transmit at least one of audio and video signals to an external device (e.g., an external display device or an external speaker) through the input/output interface 190. Specifically, an output port included in the input/output interface 190 may be connected to an external device, and the electronic device 100 may transmit at least one of audio and video signals to the external device through the output port.

The input/output interface 190 may be connected to the communication circuit 110. The input/output interface 190 may transmit information received from an external device to the communication circuit or transmit information received through the communication interface to the external device.

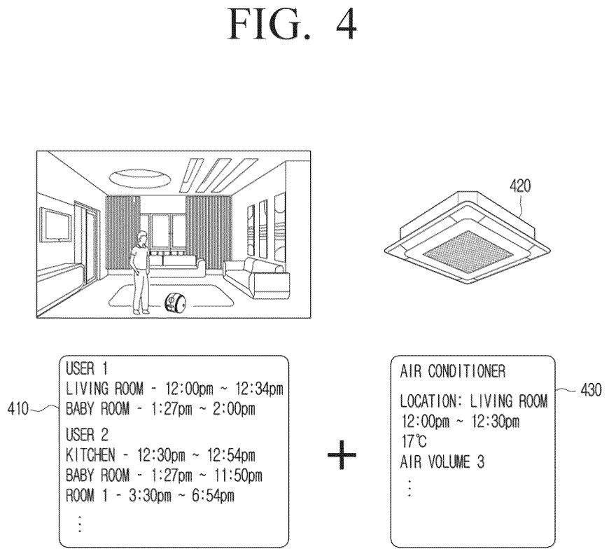

FIG. 4 is a view provided to explain a process of obtaining integrated data of an electronic device according to one or more embodiments.

According to an embodiment, the electronic device 100 may obtain integrated data based on operation log data of a device and location log data of a user for each space.

According to an embodiment, the electronic device 100 may receive operation log data for each of a plurality of devices from each of the plurality of devices through the communication circuit 110.

According to an embodiment, the electronic device 100 may move to the location of each of the plurality of devices, and obtain operation log data for each of the plurality of devices based on data obtained through the sensor 140.

According to an embodiment, the electronic device 100 may move to a location of a device among a plurality of devices which are unable to perform communication with the electronic device 100 (hereinafter, referred to as a first device), and obtain operation log data of the first device through the sensor 140.

According to an embodiment, the electronic device 100 may identify location information of a user for each space through the sensor 140, and obtain location log data of the user based on the location information.

According to an embodiment, the electronic device 100 may move through a space and identify user location information for each user. The electronic device 100 may identify a plurality of users (e.g., user 1, user 2), and identify user location information for each user.

According to an embodiment, the electronic device 100 may identify the user's duration of stay and movement path for each space. For example, when the user stays in the living room from 12:00 PM to 2:00 PM, the electronic device 100 may identify the user's location and duration of stay in the living room.

Referring to FIG. 4, the electronic device 100 may move through a space and obtain location log data 410 for each user. The electronic device 100 may identify user 1 and user 2 among a plurality of users, and obtain location information for each user and information about the duration of stay in a specific space.

For example, when user 1 stayed in the living room from 12:00 PM to 12:34 PM and stayed in the baby room from 1:27 PM to 2:00 PM, the electronic device 100 may obtain location log data corresponding to the living room (12:00pm-12:34 pm) and the baby room (1:27 pm-2:00 pm) for user 1.

The electronic device 100 may obtain operation log data of each device from a plurality of devices through the communication circuit 110. For example, the electronic device 100 may receive from an air conditioner 420 operation log data 430 including the location of the air conditioner, the operation time of the air conditioner, set temperature, and air volume information through the communication circuit 110.

Similarly, the electronic device 100 may obtain operation log data for each device from a plurality of devices located within the space.

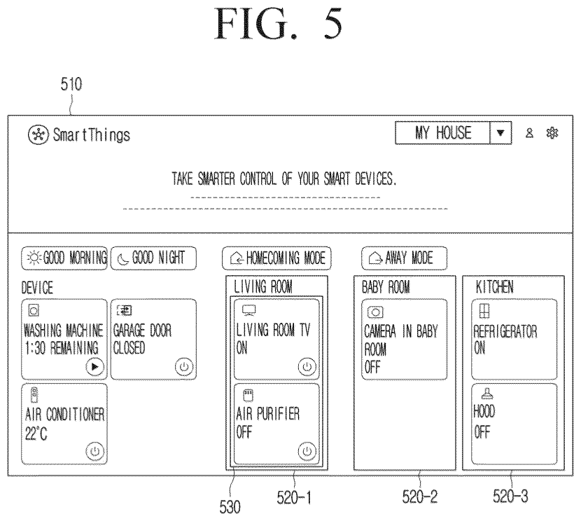

FIG. 5 is a view provided to explain integrated data according to one or more embodiments.

According to an embodiment, the electronic device 100 may identify integrated data including operation information of a plurality of devices for each user location. The electronic device 100 may identify integrated data including location information of the user and operation information of the devices in a specific space.

According to an embodiment, the electronic device 100 may classify the space in which the electronic device 100 is located and obtain log data for each space. For example, the electronic device 100 may divide the space into a living room, a baby room, and a kitchen, and obtain operation log data of devices located in the corresponding space.

According to an embodiment, the electronic device 100 may obtain operation log data of devices disposed in the space where the user is located. For example, when the user is in the living room at 1 PM, the electronic device 100 may obtain operation log data of devices disposed in the living room at 1 PM.

The integrated data may include operation log data of devices disposed in the space where the user is located with reference to the user's location. In other words, when the user is in the kitchen at a specific point in time, the electronic device 100 may obtain integrated data that integrates the location information of the user and the operation log data of devices by the operation log data of devices disposed in the kitchen at the corresponding time.

Referring to FIG. 5, the electronic device 100 may classify a space while moving. For example, the electronic device 100 may classify the space into a living room 520-1, a baby room 520-2, and a kitchen 520-3. The electronic device 100 may identify the user's location, and obtain operation log data 530 of devices disposed in the space where the user is located. The electronic device 100 may obtain location log data corresponding to the duration of stay in a specific space, movement path, and time of location based on the identified user's location. The electronic device 100 may obtain integrated data 510 by integrating the operation log data 530 of devices and the location log data of the user.

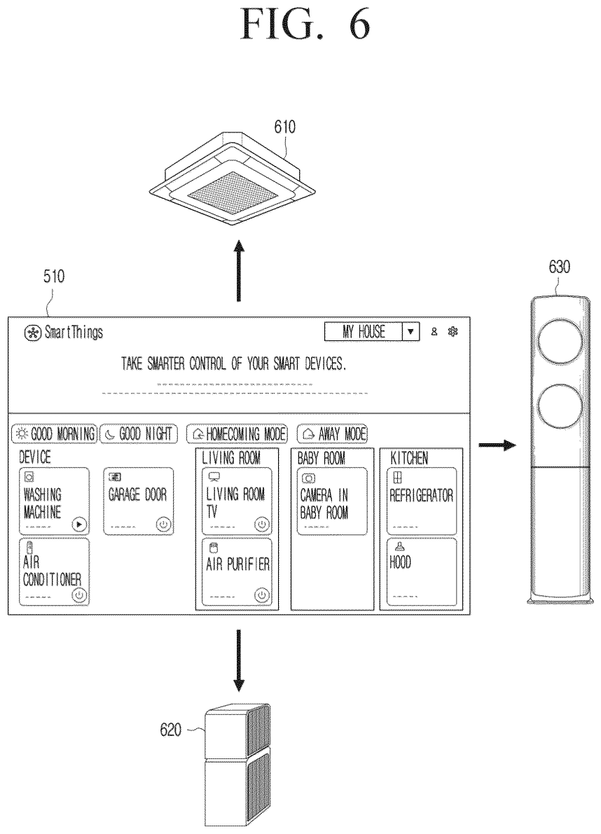

FIG. 6 is a view provided to explain a process of transmitting integrated data of an electronic device according to one or more embodiments.

According to an embodiment, the electronic device 100 may transmit the identified integrated data 510 to each of a plurality of devices. When receiving the integrated data 510 from the electronic device 100, the devices may perform operation control based on the integrated data 510. For example, when the user is located in the living room at a specific point in time, the devices disposed in the living room may perform operation control at the corresponding time through learning data based on the integrated data.

According to an embodiment, when receiving a communication connection signal from a new device through the communication circuit 110, the electronic device 100 may transmit the integrated data 510 to the new device. The new device may operate in conjunction with a plurality of devices based on the integrated data 510 received from the electronic device 100.

For example, if a new device is disposed in the living room, when the devices other than the new device disposed in the living room operate, the new device may operate in conjunction with the devices disposed in the living room based on the integrated data 510.

Referring to FIG. 6, the electronic device 100 may transmit the identified integrated data 510 to each of a plurality of devices 610, 620. The electronic device 100 may also transmit the integrated data 510 to a new device 630. In the case of a device equipped with artificial intelligence technology, it may perform learning based on the received integrated data 510 and automatically control operations at a specific point in time. In the case of the new device 630, it may operate in conjunction with the plurality of devices based on the integrated data 510.

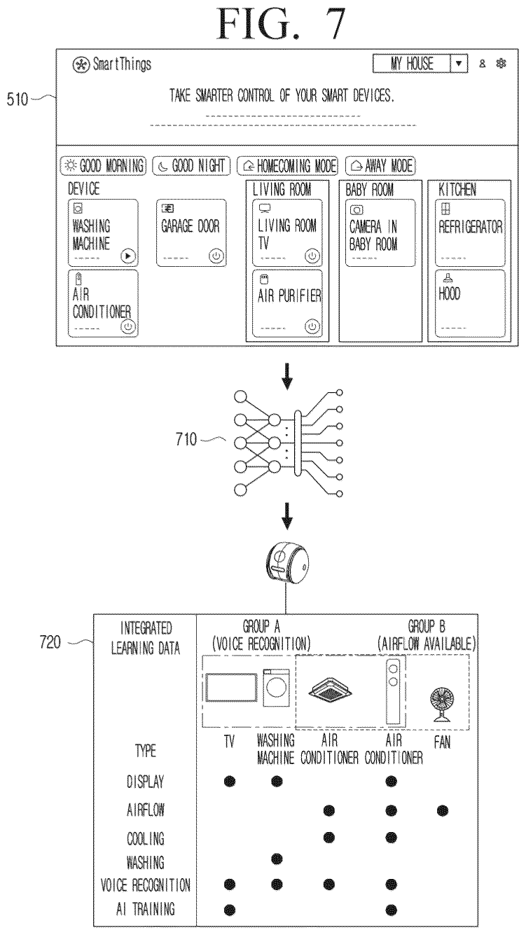

FIG. 7 is a view provided to explain a process of obtaining group information of an electronic device according to one or more embodiments.

According to an embodiment, the electronic device 100 may obtain group information including at least one device among a plurality of devices by inputting integrated data into an artificial intelligence model.

According to an embodiment, the artificial intelligence model may be trained to obtain group information based on function information for each of a plurality of devices. The function information includes a blowing function, a voice recognition function, a washing function, a cooling function, and a content output function. For example, an air conditioner, an electric fan, and an air purifier having a blowing function may be grouped into one group, and a TV, a washing machine, and an air conditioner having a voice recognition function may be grouped into another group.

According to an embodiment, the artificial intelligence model may be trained to obtain group information based on log data of a device operated by the user among a plurality of devices. For example, when the user uses an air conditioner and a TV simultaneously at a specific point in time, the artificial intelligence model may group the air conditioner and the TV into one group based on the log data of the devices included in the integrated data.

According to an embodiment, the artificial intelligence model may be trained to obtain group information based on location information of the devices. For example, when an air conditioner, an electric fan, and a TV are placed in the living room, and the user operates only the air conditioner and the TV, the artificial intelligence model may group the air conditioner and the TV into one group based on the integrated data.

Here, the phrase ‘the artificial intelligence model is trained’ means that a base artificial intelligence model (e.g., an artificial intelligence model including arbitrary random parameters) is trained using a large amount of training data by a learning algorithm, thereby generating a predefined operation rule or an artificial intelligence model configured to perform a desired characteristic (or objective). Such training may be performed through a separate server and/or system, but is not limited thereto and may also be carried out in a cooking apparatus. Examples of the learning algorithm may include a supervised learning algorithm, an unsupervised learning algorithm, a semi-supervised learning algorithm, or a reinforcement learning algorithm, but is not limited thereto.

Here, the artificial intelligence model may be implemented, for example, as a Convolutional Neural Network (CNN), a Recurrent Neural Network (RNN), a Restricted Boltzmann Machine (RBM), a Deep Belief Network (DBN), a Bidirectional Recurrent Deep Neural Network (BRDNN), or a Deep Q-Network, but is not limited thereto.

Referring to FIG. 7, the electronic device 100 may obtain group information 720 by inputting the integrated data 510 into an artificial intelligence model 710. The artificial intelligence model 710 may be trained to obtain group information 720 based on the function information of the device. The electronic device 100 may obtain the group information (720) grouped by function through the artificial intelligence model (710). For example, the electronic device 100 may obtain group information in which cassette-type air conditioners and stand-type air conditioners with a blowing function are grouped into one group through the artificial intelligence model 720.

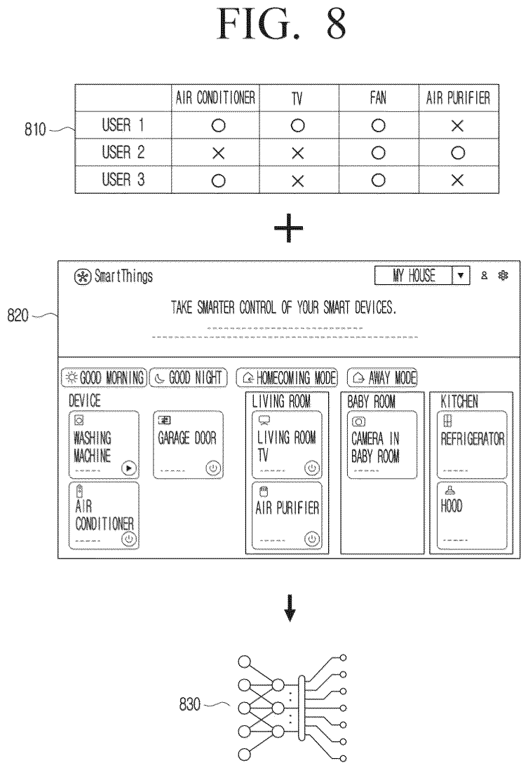

FIG. 8 is a view provided to explain a process of obtaining group information for each user of an electronic device according to one or more embodiments.

According to an embodiment, when a user is identified based on data obtained by the sensor 140, the electronic device 100 may obtain group information corresponding to the identified user by inputting information about the identified user and integrated data into an artificial intelligence model.

The information about a user may include device operation information corresponding to each of a plurality of users. For example, when user 1 among a plurality of users turns on an air conditioner and a TV at a specific point in time, the information about the user may include information about the devices operated by user 1. For example, when user 2 among a plurality of users operates a fan and an air purifier at the same time, the information about the user may include information about the devices operated by user 2.

Each of a plurality of users may operate at least one of a plurality of devices based on their lifestyle patterns. For example, user 1 may watch TV, and operate an air conditioner and a fan at 6 PM. For example, user 2 may operate a fan and an air purifier at 7 PM. As such, the types of devices used may vary depending on the user, and even for the same user, the types of devices used may vary depending on the season or time of day.

According to an embodiment, the electronic device 100 may obtain group information for each user by inputting log data and integrated data of devices used by each user into an artificial intelligence model.

According to an embodiment, the electronic device 100 may transmit a control signal identified based on group information and integrated data corresponding to the identified user to at least one device included in the same group through a communication circuit. For example, the control signal may include a signal to control the TV and air conditioner to operate at 6:00 PM for user 1.

Referring to FIG. 8, the electronic device 100 may identify a user based on data obtained by the sensor 140. For example, the electronic device 100 may receive a user list for a plurality of users from the user. The electronic device 100 may identify each of the plurality of users based on the user list. Subsequently, the electronic device 100 may obtain log data 810 regarding operation information of a plurality of devices for each location of each user.

The electronic device 100 may obtain group information for each user by inputting log data 810 and the integrated data 510 into an artificial intelligence model 830. For example, when user 1 uses an air conditioner, a TV and a fan in the living room at 6 PM, the electronic device 100 may obtain group information for user 1 in which the air conditioner, the TV, and the fan are grouped into one group. For example, when user 2 uses a fan and an air purifier in the baby room at 6 PM, the electronic device 100 may obtain group information for user 2 in which the fan and the air purifier are ground into one group.

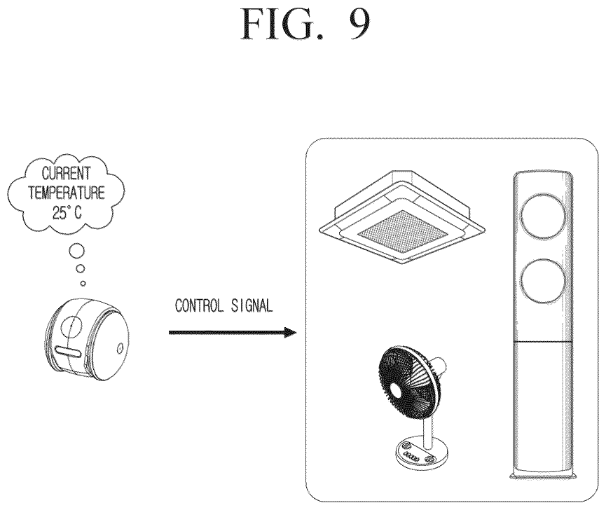

FIG. 9 is a view provided to explain a process of transmitting a control signal of an electronic device according to one or more embodiments.

According to an embodiment, the electronic device 100 may obtain a control signal for at least one device included in a group based on group information and integrated data. The control signal may be a signal including control information for operating a device. The electronic device 100 may transmit the same control signal to a plurality of devices included in a group. On the other way, the electronic device 100 may transmit different control signals to each of a plurality of devices included in a group.

For example, when an air conditioner, a fan and an air purifier with a blowing function are grouped into one group, the electronic device 100 may obtain a control signal for each of the air conditioner, the fan, and the air purifier to set the indoor temperature to 18 degrees.

According to an embodiment, the electronic device 100 may obtain information about the space in which the electronic device 100 is located based on data obtained by the sensor 140, and obtain a control signal based on the information about the space, group information and integrated data.

The information about the space may include environmental indicator data about the space. For example, the information about the space may include information corresponding to the temperature, humidity, air pollution levels and carbon dioxide concentrations of the space. The electronic device 100 may move through a space and obtain information about the space through the sensor 140.

According to an embodiment, the electronic device 100 may obtain a control signal for a group using group information and integrated data based on information about the space. For example, when the temperature of the space is 25 degrees at 12 PM, the electronic device 100 may obtain a control signal for a group including a blowing function based on the integrated data.

Referring to FIG. 9, the electronic device 100 may obtain information about an indoor space at a specific point in time through the sensor 140. The electronic device 100 may compare information about the actually sensed space with the log data included in the integrated data based on the integrated data at the corresponding point in time. The electronic device 100 may obtain a control signal based on the comparison data. The electronic device 100 may identify a group corresponding to the obtained control signal, and transmit the control signal to the identified group.

For example, when the temperature of the indoor space is 25 degrees at 12 PM, the electronic device 100 may identify operation information of the device based on the integrated data as of 12 PM. When the user sets the temperature to 17 degrees by using the air conditioner or fan at 12 PM, a control signal to set the indoor temperature to 17 degrees may be obtained.

The electronic device 100 may identify the user's location, and identify a group having a blowing function at the user's location. The electronic device 100 may transmit a control signal to the identified group.

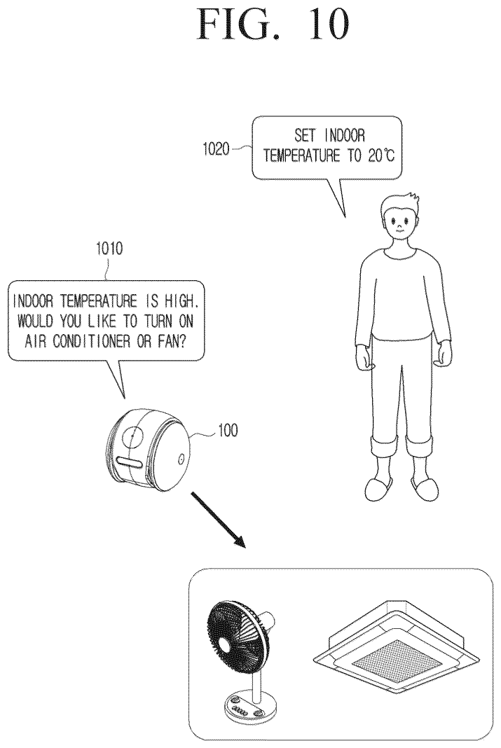

FIG. 10 is a view provided to explain a process of providing guide information of an electronic device according to one or more embodiments.

According to an embodiment, the electronic device 100 may output guide information corresponding to a control signal identified based on group information and integrated data through the speaker 160. The guide information may be information provided to the user in the form of text or voice, corresponding to the control signal. For example, the guide information may include messages such as “The laundry is finished. Shall I start the dryer?” or “The room temperature is high. Shall I turn on the air conditioner?”

According to an embodiment, when a response command for guide information is received, the electronic device 100 may transmit a control signal to at least one device through the communication circuit 110.

Referring to FIG. 10, the electronic device 100 may identify information about the indoor space through the sensor 140, and provide guide information 1010 corresponding to the identified information to the user through the speaker 160. For example, when the indoor temperature based on sensing data sensed at 1 PM is higher than the indoor temperature based on the integrated data at 1 PM, the electronic device 100 may output the guide information 1010 such as “The room temperature is high. Shall I turn on the air conditioner or fan?” through the speaker 160.

Subsequently, when a response command 1020 for the guide information is received from the user, the electronic device 100 may transmit a control signal to reduce the indoor temperature to at least one device. The electronic device 100 may also transmit a control signal to a group including a blowing function.

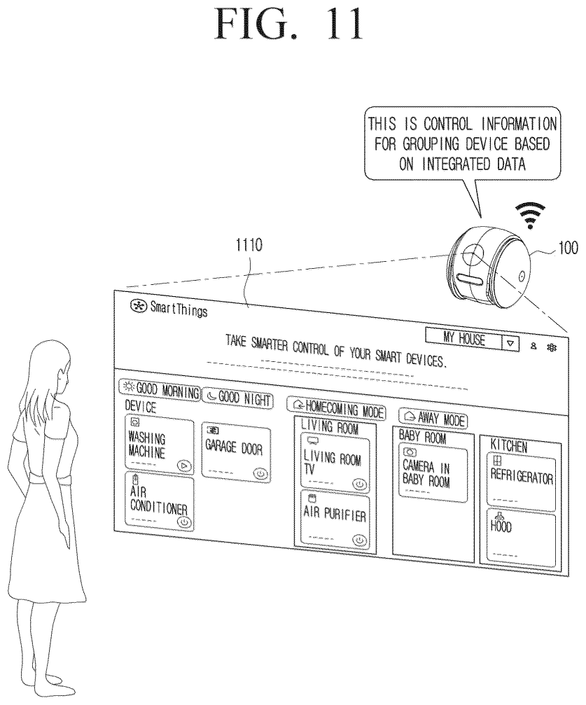

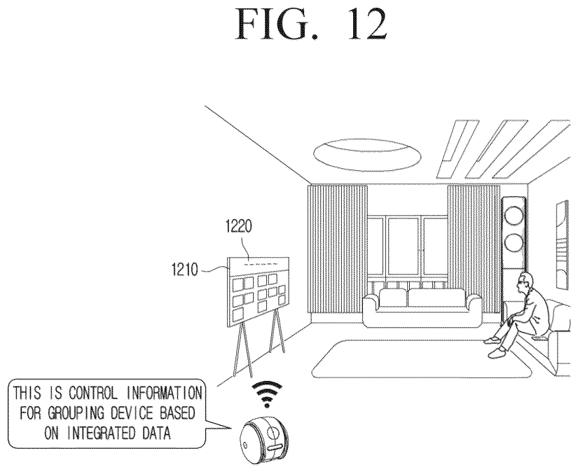

FIGS. 11 and 12 are views provided to explain a process of providing information through a projector of an electronic device according to one or more embodiments.

According to an embodiment, when a user is identified, the electronic device 100 may move to the user's location and project group information based on integrated data through the projector 170. When a device included in a group is changed and the group information is updated, the electronic device 100 may project the updated group information through the projector 170.

According to an embodiment, the electronic device 100 may project guide information corresponding to a control signal identified based on group information and integrated data through the projector 170.

According to an embodiment, when a response command for the guide information is received, the electronic device 100 may transmit a control signal to at least one device through the communication circuit 110.

Referring to FIG. 11, when a user is identified, the electronic device 100 may move to the user's location and project group information based on integrated data through the projector 170. The electronic device 100 may project guide information corresponding to a control signal identified based on the group information and the integrated data through the projector 170.

According to an embodiment, when the electronic device 100 is unable to move to the user's location, the group information based on the integrated data may be provided through an external device that performs communication with the electronic device 100.

Referring to FIG. 12, when the electronic device 100 is located on the first floor and the user is located on the second floor, the electronic device 100 may provide the user with group information 1220 based on integrated data through a TV 1210 that the user is watching. The electronic device 100 may transmit the group information to the TV 1210 that the user is watching, and transmit a control signal to the TV 1210 to display the group information through a display included in the TV 1210.

According to an embodiment, the electronic device 100 may transmit a control signal to an external display device to output a guide information User Interface (UI) corresponding to a control signal identified based on group information and integrated data through a display device. The electronic device 100 may transmit a User Interface (UI) corresponding to the guide information to the external display device. The electronic device 100 may transmit a control signal to the external display device to output the guide information UI through the display of the external display device.

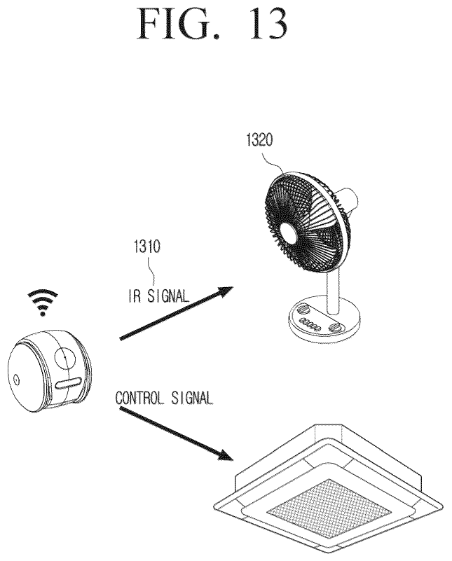

FIG. 13 is a view provided to explain a process of controlling a device using an IR signal according to one or more embodiments.

According to an embodiment, when a first device included in the same group is a device that is unable to perform communication, the electronic device 100 may move to the location of the first device and transmit an IR signal corresponding to the control signal to the first device through an IR sensor.

The plurality of devices may include devices capable of performing communication with the electronic device 100 and devices incapable of performing communication with the electronic device 100. The devices incapable of performing communication with the electronic device 100 may be legacy devices. The legacy devices may be devices manufactured based on older technologies and older systems, and may be devices manufactured with an operating system and software different from those of the latest devices.

The legacy devices may be devices that are not connectable or compatible with an IoT server or a plurality of IoT devices in an IoT environment including a plurality of IoT devices. The legacy devices may be devices that use a previous generation communication protocol instead of a communication protocol currently used by the IoT server, or may be devices that do not support a standardized IoT protocol.

The plurality of IoT devices may perform communication with each other to transmit and receive data. On the other hand, a legacy device may not be able to transmit or receive data with a plurality of devices due to the problem of not being able to connect to an IoT server or a plurality of IoT devices. The legacy device may include an IR receiver and may be capable of sensing IR signals. In this case, the electronic device 100 may identify the location of the legacy device, move to the area where the legacy device is located and transmit an IR signal to the legacy device through an IR sensor.

In this case, the electronic device 100 may not receive log data from the first device, and may also not transmit a control signal based on integrated data to the first device. The electronic device 100 may move through a space to identify the first device, and transmit an IR signal corresponding to the control signal to the first device through an IR sensor among sensors attached to the electronic device 100.

Referring to FIG. 13, the electronic device 100 may move through a space and identify a first device 1310. When among the group information obtained by the electronic device 100, one group includes the first device 1310 and an air conditioner, the electronic device 100 may control the first device 1310 through an IR signal 1320. On the other hand, the electronic device 100 may transmit a control signal to the air conditioner through the communication circuit 110.

According to an embodiment, the electronic device 100 may obtain a control signal of a device included in a group based on energy usage. The electronic device may obtain a control signal of a device included in one group for optimal energy consumption according to season, time and electricity price.

For example, when the electricity price for a device used during the evening is higher than that during the daytime, the electronic device 100 may obtain a control signal for reducing power consumption in the evening compared to the daytime. For instance, when the indoor temperature is set by operating only the air conditioner during the daytime, the electronic device 100 may set the indoor temperature by operating both the air conditioner and the fan during the evening.

According to an embodiment, the electronic device 100 may control the operating time of the device differently depending on at least one of the time zone or the presence of a user in the indoor space. For example, when a user is not identified in the indoor space, the electronic device 100 may control the operation time of the washing machine to be increased compared to when a user is identified in the indoor space. The washing machine can reduce power consumption when performing a two-hour wash compared to a one-hour wash. Accordingly, the electronic device 100 may transmit a control signal to the washing machine to increase the operation time when a user is not identified in the indoor space.

According to an embodiment, the electronic device 100 may obtain a control signal for a plurality of devices included in a group through an artificial intelligence model trained based on energy usage. The artificial intelligence model may be trained to obtain a control signal for the devices based on at least one of time of day, season, or energy usage. For example, when the energy consumption on a specific day is greater than the average daily energy consumption, the electronic device 100 may obtain a control signal for the devices to reduce energy consumption on the corresponding day.

According to an embodiment, the electronic device 100 may control the projector 170 based on a user voice signal received through the microphone 150. For example, when a user voice signal for projecting A UI is received, the electronic device 100 may control the projector 170 to display A UI.

According to an embodiment, the electronic device 100 may control an external display device connected to the electronic device 100 based on a user voice signal received through the microphone 150. Specifically, the electronic device 100 may generate a control signal for controlling the external display device so that an operation corresponding to the user voice signal is performed on the external display device, and transmit the generated control signal to the external display device. Here, the electronic device 100 may store a remote control application for controlling the external display device. Then, the electronic device 100 may transmit the generated control signal to the external display device using at least one communication method among Bluetooth, Wi-Fi, or infrared. For example, when a user voice signal for displaying content A is received, the electronic device 100 may transmit a control signal for controlling the content A to be displayed on the external display device to the external display device. Here, the electronic device 100 may mean various terminal devices capable of installing a remote control application, such as a smart phone or an AI speaker.

According to an embodiment, the electronic device 100 may use a remote control device to control an external display device connected to the electronic device 100 based on a user voice signal received through the microphone 150. Specifically, the electronic device 100 may transmit a control signal for controlling the external display device to the remote control device so that an operation corresponding to the user voice signal is performed on the external display device. In addition, the remote control device may transmit a control signal received from the electronic device 100 to the external display device. For example, when a user voice signal for displaying content A is received, the electronic device 100 may transmit a control signal for controlling the A content to be displayed on the external display device to the remote control device, and the remote control device may transmit the received control signal to the external display device.

According to an embodiment, the communication circuit 110 may use the same communication module (e.g., a Wi-Fi module) to communicate with an external device, such as a remote control device, and an external server.

According to an embodiment, the communication circuit 110 may use different communication modules to perform communication with an external device such as a remote control device and an external server. For example, the communication circuit 110 may use at least one of an Ethernet module or a Wi-Fi module to perform communication with an external server, and may use a Bluetooth module to perform communication with an external device such as a remote control device. However, this is only one embodiment, and the communication circuit 110 may use at least one of various communication modules when performing communication with a plurality of external devices or external servers.

According to an embodiment, the electronic device 100 may receive a user voice signal through the microphone 150 included in the electronic device 100.

According to an embodiment, the electronic device 100 may receive a user voice signal from an external device including a microphone. Here, the external device may mean a remote control device or a smartphone, etc. Here, the received user voice signal may be a digital voice signal, but may be an analog voice signal according to an implementation example. The electronic device 100 may receive a user voice signal through a wireless communication method such as Bluetooth or Wi-Fi.

According to an embodiment, the electronic device 100 may obtain text information corresponding to a user voice signal from an external server. Specifically, the electronic device 100 may transmit a user voice signal (audio signal or digital signal) to an external server. Here, the external server may mean a voice recognition server. Here, the voice recognition server may convert a user voice signal into text information using Speech To Text (STT). Then, the external server may transmit text information corresponding to the converted user voice signal to the electronic device 100.

According to an embodiment, the electronic device 100 may obtain text information corresponding to a user voice signal on its own. Specifically, the electronic device 100 may directly apply a Speech To Text (STT) function to a digital voice signal to convert it into text information and transmit the converted text information to an external server.

According to an embodiment, an external server may transmit text information corresponding to a user voice signal to the electronic device 100. Specifically, the external server may be a server that performs a voice recognition function that converts a user voice signal into text information.

According to an embodiment, the external server may transmit at least one of text information corresponding to the user voice signal or search result information corresponding to the text information to the electronic device 100. Specifically, the external server may be a server that performs a search result providing function that provides search result information corresponding to the text information in addition to a voice recognition function that converts the user voice signal into text information.

For example, the external server may be a server that performs both the voice recognition function and the search result providing function. As another example, the external server may perform only the voice recognition function, and the search result providing function may be performed by a separate server. The external server may transmit text information to a separate server to obtain a search result, and obtain the search result corresponding to the text information from the separate server.

According to an embodiment, a communication module for communication with an external device and an external server may be implemented in the same manner. For example, the electronic device 100 may perform communication with the external device using a Bluetooth module, and may also perform communication with the external server using a Bluetooth module.

According to an embodiment, the communication module for communication with an external device and an external server may be implemented separately. For example, the electronic device 100 may perform communication with an external device using a Bluetooth module, and may perform communication with an external server using an Ethernet modem or a Wi-Fi module.

According to an embodiment, the electronic device 100 may identify integrated data, and the operation of obtaining group information may be performed by an external server. Specifically, the external server may receive operation log data of the device and location log data of the user from the electronic device 100, and may identify integrated data including operation information of a plurality of devices for each user location based on the received data. The external server may input the integrated data into an artificial intelligence model to obtain group information including at least one of the plurality of devices. The external server may transmit the integrated data and the group information to the electronic device 100.

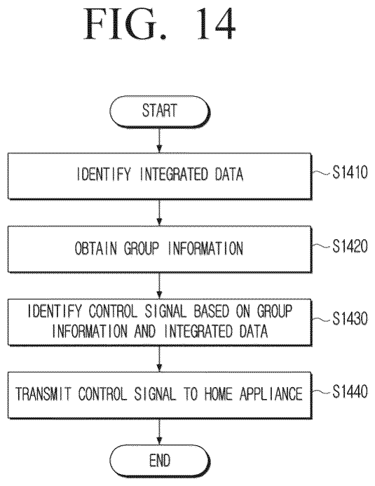

FIG. 14 is a view provided to explain an operation process of an electronic device according to one or more embodiments.

Referring to FIG. 14, in operation 1410, the electronic device 100 may identify integrated data including operation information of a plurality of devices for each user location based on a plurality of operation log data received from the plurality of devices and location log data of the user for each space.

In operation 1420, the electronic device 100 may input the integrated data into an artificial intelligence model to obtain group information including at least one device among the plurality of devices.

In operation 1430, the electronic device 100 may identify a control signal for the device based on the group information and the integrated data.

In operation 1440, the electronic device 100 may transmit a control signal identified based on the group information and the integrated data to at least one device included in the same group.

Since the specific method of identifying the integrated data and inputting the integrated data into an artificial intelligence model to obtain the group information has been described through the above-mentioned embodiments, a detailed description thereof will be omitted.

The controlling method described in FIG. 14 may be performed by the electronic device 100 having the configuration of FIG. 2 described above, but is not necessarily limited thereto and may be performed by electronic devices having various configurations.

The various embodiments described above may be implemented individually, or at least one embodiment may be implemented in combination with others, either entirely or partially, in a single device.

According to the various embodiments described above, the electronic device 100 may control a plurality of devices in an integrated manner based on integrated data that takes into account the user's location, and may control the plurality of devices by group through group information.

Meanwhile, the various embodiments described above may be applied to a product individually, but at least a part of the contents may also be implemented in combination with other embodiments of the present disclosure.

Meanwhile, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic device (e.g., electronic device A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product.

Specifically, based on a plurality of operation log data and user location log data for each space received from a plurality of devices, integrated data including operation information of the plurality of devices for each user location may be identified; group information including at least one device among the plurality of devices may be obtained by inputting the integrated data into an artificial intelligence model; and a control signal identified based on the group information and the integrated data may be transmitted to at least one device included in the same group.

The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as memory of a server of a manufacturer, a server of an application store, or a relay server, or may be temporarily generated.

Further, computer instructions or programs for performing a controlling method of an electronic device according to the above-described various embodiments may be stored in a non-transitory computer-readable medium. When being executed by a processor of a specific device, the computer instructions stored in such a non-transitory computer-readable medium allows the specific device to perform processing operations in the electronic device according to the above-described various embodiments. The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

1. An electronic device comprising:
a communication circuit;
a memory configured to store instructions; and
one or more processors including processing circuitry configured to, individually or collectively, execute the stored instructions to:
obtain integrated data including operation information of a plurality of devices, location information of the plurality of devices, and location information of a user, obtain group information including at least one device among the plurality of devices through an artificial intelligence model based on the integrated data; and
transmit a control signal identified based on the integrated data and the group information to at least one device included in the same group through the communication circuit.

2. The device as claimed in claim 1, further comprising:
a sensor,
wherein the instructions, when executed by the one or more processors individually or collectively, cause the electronic device to:
based on the user being identified based on data obtained by the sensor, obtain group information corresponding to the identified user through the artificial intelligence model based on information corresponding to the identified user and the integrated data; and
transmit a control signal identified based on the group information corresponding to the identified user and the integrated data to at least one device included in the same group through the communication circuit.

3. The device as claimed in claim 1, wherein the instructions, when executed by the one or more processors individually or collectively, cause the electronic device to:
receive operation data for each of the plurality of devices, which is a basis of the integrated data, from each of the plurality of devices through the communication circuit.

4. The device as claimed in claim 1, further comprising:
a sensor,
wherein the instructions, when executed by the one or more processors individually or collectively, cause the electronic device to:
move to a location of each of the plurality of devices and obtain operation data for each of the plurality of devices based on data obtained through the sensor.

5. The device as claimed in claim 1, wherein the instructions, when executed by the one or more processors individually or collectively, cause the electronic device to:
based on a signal corresponding to a communication connection being received from a device through the communication circuit, transmit the integrated data to the device through the communication circuit; and
operate in conjunction with the device that received the integrated data.

6. The device as claimed in claim 1, further comprising:
a sensor,
wherein the instructions, when executed by the one or more processors individually or collectively, cause the electronic device to:
obtain information corresponding to a space where the electronic device is located based on data obtained by the sensor; and
obtain the control signal based on information corresponding to the space, the group information and the integrated data.

7. The device as claimed in claim 1, further comprising:
a speaker,
wherein the instructions, when executed by the one or more processors individually or collectively, cause the electronic device to:
output information corresponding to a signal based on the group information and the integrated data through the speaker; and
based on a user input for information corresponding to the control signal being received, transmit the control signal to at least one home appliance through the communication circuit.

8. The device as claimed in claim 1, further comprising:
a projector,
wherein the instructions, when executed by the one or more processors individually or collectively, cause the electronic device to:
project information corresponding to a control signal identified based on the group information and the integrated data through the projector; and
based on a user input for information corresponding to the control signal being received, transmit the control signal to the at least one home appliance through the communication circuit.

9. The device as claimed in claim 1, further comprising:
an IR sensor,
wherein the instructions, when executed by the one or more processors individually or collectively, cause the electronic device to:
based on a communication connection with a first device included in the same group being not possible, move to a location of the first device and output an IR signal corresponding to the control signal through the IR sensor.

10. The device as claimed in claim 1, wherein the instructions, when executed by the one or more processors individually or collectively, cause the electronic device to:
obtain the integrated data corresponding to the operation information of the plurality of devices for each user location based on a plurality of operation data and user location data for each space received from the plurality of devices.

11. A controlling method of an electronic device, comprising:
obtaining integrated data including operation information of a plurality of devices, location information of the plurality of devices, and location information of a user, obtaining group information including at least one device among the plurality of devices through an artificial intelligence model based on the integrated data; and
transmitting a control signal identified based on the integrated data and the group information to at least one device included in the same group.

12. The method as claimed in claim 11, comprising:
based on the user being identified, obtaining group information corresponding to the identified user through the artificial intelligence model based on information corresponding to the identified user and the integrated data; and
transmitting a control signal identified based on the group information corresponding to the identified user and the integrated data to at least one device included in the same group.

13. The method as claimed in claim 11, comprising:
receiving operation data for each of the plurality of devices, which is a basis of the integrated data, from each of the plurality of devices.

14. The method as claimed in claim 11, comprising:
moving to a location of each of the plurality of devices and obtain operation data for each of the plurality of devices based on data obtained through the electronic device.

15. A non-transitory computer-readable recording medium storing computer instructions that, when executed by a processor of an electronic device, cause the electronic device to:
obtain integrated data including operation information of a plurality of devices, location information of the plurality of devices, and location information of a user,
obtain group information including at least one device among the plurality of devices by inputting the integrated data into an artificial intelligence model; and
transmit a control signal identified based on the integrated data and the group information to at least one device included in the same group.
